(19) United States
(12) Patent Application Publication
(10) Pub. No.: US 2020/0149620 A1
(43) Pub. Date: May 14, 2020

(54) TORSIONAL VIBRATION DAMPER AND LOCK-UP CLUTCH FOR HYDROKINETIC TORQUE-COUPLING DEVICE, AND METHOD FOR MAKING THE SAME

(71) Applicant: VALEO EMBRAYAGES, Amiens (FR)

(72) Inventor: Subramanian JEYABALAN, Daegu (KR)

(73) Assignee: VALEO EMBRAYAGES, Amiens (FR)

(21) Appl. No.: 16/627,438

(22) PCT Filed: Jul. 2, 2018
(86) PCT No.: PCT/EP2018/067848

§ 371 Date: Dec. 30, 2019

Related U.S. Application Data
(63) Continuation of application No. 15/638,905, filed on Jun. 30, 2017, now abandoned.

(51) Int. Cl. F16H 45/02; F16F 15/133; F16F 15/123; F16F 15/121; F16D 25/0635

(52) U.S. Cl. CPC F16H 45/02; F16F 15/1333; F16F 15/12306; F16F 15/1215; F16F 15/1213; F16H 2045/007; F16D 25/0635; F16H 2045/0278; F16H 2045/0221; F16H 2045/0205; F16F 15/121

(57) ABSTRACT

A torsional vibration damper comprises an axially movable locking piston including a piston plate, a torque input member including a cover plate, a support plate disposed axially opposite the cover plate and a supporting member mounted to both the cover and support plates, and a unitary radially elastic output member pivotable relative to and elastically coupled to the torque input member. The output member is disposed axially between the cover plate and the piston plate. The output member includes an output hub and a curved elastic blade configured to elastically and radially engage the supporting member and to elastically bend in the radial direction upon rotation of the cover plate with respect to the output member. The cover plate at least partially covers an axially first outer surface of the output member. The support plate partially covers an axially second outer surface of the output member.

### BACKGROUND OF THE INVENTION

### 1. Field of the Invention

The present invention generally relates to fluid coupling devices, and more particularly to a torsional vibration damper for hydrokinetic torque-coupling devices, and a method for making the same.

### 2. Background of the Invention

A conventional hydrokinetic torque-coupling device 1 is schematically and partially illustrated in FIG. 1 and is configured to transmit torque from an output shaft of an internal combustion engine of a motor vehicle, such as for instance a crankshaft 2a, to a transmission input shaft 2b. The conventional hydrokinetic torque-coupling device comprises a hydrokinetic torque converter 4 and a torsional vibration damper 5. The hydrokinetic torque converter conventionally comprises an impeller wheel 4i, a turbine wheel 4t, a stator (or reactor) 4s fixed to a casing of the torque converter 4, and a one-way clutch for restricting rotational direction of the stator 8 to one direction. The impeller wheel 4i is configured to hydro-kinetically drive the turbine wheel 4t through the reactor 4s. The impeller wheel 4i is coupled to the crankshaft 1 and the turbine wheel 4t is coupled to a guide washer 6.

The torsional vibration damper 5 of the compression spring-type comprises a first group of coil springs 7a, 7b mounted between the guide washer 6 and an output hub 8 coupled to the transmission input shaft 2b. The coil springs 7a, 7b of the first group are arranged in series through a phasing member 9, so that the coil springs 7a, 7b are deformed in phase with each other, with the phasing member 9 being movable relative to the guiding washer 6 and relative to the output hub 8. A second group of coil springs 7c is mounted with some clearance between the guide washer 6 and the output hub 8 in parallel with the first group of elastic members 7a, 7b, with the coil springs 7c being adapted to be active in a limited angular range, more particularly at the end of the angular travel of the guide washer 6 relative to the output hub 8. The angular travel, or the angular shift α, of the guide washer 6 relative to the output hub 8, is defined relative to a rest position (α=0) wherein no torque is transmitted through damping means formed by the coil springs 7a, 7b. The second group of coil springs 7c makes it possible to increase the stiffness of the damping means at the end of angular travel, i.e. for a significant α angular offset of the guide washer 6 relative to the output hub 8 (or vice versa).

The torque-coupling device 1 further comprises a lock-up clutch 3 adapted to transmit torque from the crankshaft 2a to the guide washer 6 in a determined operation phase, without action from the impeller wheel 4i and the turbine wheel 4t.

The turbine wheel 4t is integrally or operatively connected with the output hub 8 linked in rotation to a driven shaft, which is itself linked to an input shaft of a transmission of a vehicle. The casing of the torque converter 4 generally includes a front cover and an impeller shell which together define a fluid filled chamber. Impeller blades are fixed to an impeller shell within the fluid filled chamber to define the impeller assembly. The turbine wheel 4t and the stator 4s are also disposed within the chamber, with both the turbine wheel 4t and the stator 4s being relatively rotatable with respect to the front cover and the impeller wheel 4i. The turbine wheel 4t includes a turbine shell with a plurality of turbine blades fixed to one side of the turbine shell facing the impeller blades of the impeller wheel 4i.

The turbine wheel 4t works together with the impeller wheel 4i, which is linked in rotation to the casing that is linked in rotation to a driving shaft driven by an internal combustion engine. The stator 4s is interposed axially between the turbine wheel 4t and the impeller wheel 4i, and is mounted so as to rotate on the driven shaft with the interposition of the one-way clutch.

While conventional hydrokinetic torque-coupling devices, including but not limited to those discussed above, have proven to be acceptable for vehicular driveline applications and conditions, improvements that may enhance their performance and cost are possible.

### BRIEF SUMMARY OF THE INVENTION

According to a first aspect of the invention, there is provided a hydrokinetic torque-coupling device for coupling a driving shaft and a driven shaft together, comprising a casing rotatable about a rotational axis and having a locking surface. The device comprises also a torque converter including an impeller wheel rotatable about the rotational axis and a turbine wheel disposed in the casing coaxially with the rotational axis, the turbine wheel disposed axially opposite to the impeller wheel and hydro-dynamically rotationally drivable by the impeller wheel. A lock-up clutch including a locking piston is axially movable along the rotational axis to and from the locking surface of the casing, the locking piston including a substantially radially oriented piston plate. A torsional vibration damper comprises a torque input member including a substantially radially oriented cover plate, a support plate disposed axially opposite the cover plate, and at least one supporting member disposed between the cover plate and the support and mounted to both the cover plate and the support plate; and a unitary radially elastic output member pivotable relative to and elastically coupled to the torque input member, the radially elastic output member disposed axially between the cover plate and the support plate. The radially elastic output member includes an output hub coaxial with the rotational axis and rotatable relative the torque input member, and at least one curved elastic blade non-movably connected to the output hub and configured to elastically and radially engage the at least one supporting member and to elastically bend in the radial direction upon rotation of the cover plate with respect to the radially elastic output member. The at least one elastic blade defining a curved raceway configured to bear the at least one supporting member. The locking piston is non-rotatably coupled to the support plate of the torque input member of the torsional vibration damper. The radially elastic output member is covered from axially opposite sides by the support plate and the cover plate. The cover plate at least partially covers an axially first outer surface of the radially elastic output member facing the cover plate. The support plate partially covers an axially second outer surface of the radially elastic output member facing the support plate. The locking piston has an engagement surface configured to selectively frictionally engage the locking surface of the casing to position the hydrokinetic torque-coupling device into and out of a lockup mode in which the locking piston is mechanically frictionally locked to the casing so as to be non-rotatable relative to the casing.

According to the first aspect of the invention:

the cover plate covers no less than 70% of an area of the axially first outer surface of the radially elastic output member facing the cover plate, and the support plate covers no more than 90% of an area of the axially second outer surface of the radially elastic output member facing the support plate.

the support plate is an annular plate.

the impeller wheel includes an impeller shell and the turbine wheel includes a turbine shell disposed axially opposite the impeller shell, and wherein the casing includes the impeller shell and a cover shell non-movably connected to the impeller shell to establish the casing.

the locking piston includes at least one coupling lug axially extending from the locking piston toward the torsional vibration damper, wherein the support plate includes at least one notch positively engaged by the at least one coupling lug so as to non-rotatably couple the locking piston and the support plate.

According to a second aspect of the invention, there is provided a hydrokinetic torque-coupling device for coupling a driving shaft and a driven shaft together. The hydrokinetic torque-coupling device comprises a casing rotatable about a rotational axis and having a locking surface, a torque converter including an impeller wheel rotatable about the rotational axis and a turbine wheel disposed in the casing coaxially with the rotational axis, a lock-up clutch including a locking piston axially movable along the rotational axis to and from the locking surface of the casing, and a torsional vibration damper. The turbine wheel is disposed axially opposite to the impeller wheel and is hydro-dynamically rotatably drivable by the impeller wheel. The locking piston includes a substantially radially oriented piston plate. The torsional vibration damper comprises a torque input member, and a unitary radially elastic output member pivotable relative to and elastically coupled to the torque input member. The torque input member includes a substantially radially oriented cover plate, a support plate disposed axially opposite the cover plate, and at least one supporting member disposed between the cover plate and the support and mounted to both the cover plate and the support plate. The radially elastic output member is disposed axially between the cover plate and the support plate. The radially elastic output member includes an output hub coaxial with the rotational axis and rotatable relative the torque input member, and at least one curved elastic blade non-movably connected to the output hub. The at least one curved elastic blade is configured to elastically and radially engage the at least one supporting member and to elastically bend in the radial direction upon rotation of the cover plate with respect to the radially elastic output member. The at least one elastic blade defines a curved raceway configured to bear the at least one supporting member. The locking piston is non-rotatably coupled to the cover plate of the torque input member of the torsional vibration damper. The radially elastic output member is covered from axially opposite sides only by the piston plate and the cover plate. The cover plate at least partially covers an axially first outer surface of the radially elastic output member facing the cover plate. The support plate partially covers an axially second outer surface of the radially elastic output member facing the support plate. The locking piston has an engagement surface configured to selectively frictionally engage the locking surface of the casing to position the hydrokinetic torque-coupling device into and out of a lockup mode in which the locking piston is mechanically frictionally locked to the casing so as to be non-rotatable relative to the casing. The object of the present invention is to reduce the weight of the hydrokinetic torque-coupling device, lessen the cost thereof and enable better fluid circulation therewithin.

According to a third aspect of the present invention, there is provided a torsional vibration damper rotatable about a rotational axis. The torsional vibration damper comprises a locking piston axially movable along the rotational axis and including a substantially radially oriented piston plate, a torque input member and a unitary radially elastic output member pivotable relative to and elastically coupled to the torque input member. The torque input member includes a substantially radially oriented cover plate, a support plate disposed axially opposite the cover plate, and at least one supporting member disposed between the cover plate and the support and mounted to both the cover plate and the support plate. The radially elastic output member is disposed axially between the cover plate and the piston plate. The radially elastic output member includes an output hub coaxial with the rotational axis and rotatable relative the torque input member, and at least one curved elastic blade non-movably connected to the output hub. The at least one curved elastic blade is configured to elastically and radially engage the at least one supporting member and to elastically bend in the radial direction upon rotation of the cover plate with respect to the radially elastic output member. The at least one curved elastic blade defines a curved raceway configured to bear the at least one supporting member. The locking piston is non-rotatably coupled to the cover plate of the torque input member. The radially elastic output member is covered from axially opposite sides only by the piston plate and the cover plate. The cover plate at least partially covers an axially first outer surface of the radially elastic output member facing the cover plate. The support plate partially covers an axially second outer surface of the radially elastic output member facing the support plate. The object of the present invention is to reduce the weight of the torsional vibration damper and lessen the cost thereof.

According to a fourth aspect of the present invention, there is provided a method for assembling a torsional vibration damper for a hydrokinetic torque-coupling device for coupling a driving shaft and a driven shaft together. The method involves the steps of providing a piston plate, a cover plate, a support plate and at least one supporting member, providing a unitary radially elastic output member including an output hub and at least one curved elastic blade non-movably connected to the output hub and configured to elastically and radially engage the at least one supporting member and to elastically bend in the radial direction, mounting the at least one supporting member to the cover plate, placing the unitary radially elastic member axially between the cover plate and the piston plate so that the at least one elastic blade elastically and radially engages the at least one supporting member, mounting the support plate to the cover plate so that the at least one supporting member is disposed between the cover plate and the support plate, and non-rotatably mounting the piston plate to the cover plate so that the radially elastic output member being entirely covered from axially opposite sides only by the piston plate and the cover plate. The cover plate at least partially covers an axially first outer surface of the radially elastic output member facing the cover plate. The support plate partially covers an axially second outer surface of the radially elastic output member facing the support plate. The object of the present invention is to reduce labor and cost of manufacturing of the hydrokinetic torque-coupling device.

Other aspects of the invention, including apparatus, devices, systems, converters, processes, and the like which constitute part of the invention, will become more apparent upon reading the following detailed description of the exemplary embodiments.

### BRIEF DESCRIPTION OF THE SEVERAL VIEWS OF THE DRAWING(S)

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 is a schematic representation of a torque-coupling device of the related art;

FIG. 2 is a fragmented half-view in axial section of a hydrokinetic torque-coupling device in accordance with a first exemplary embodiment of the present invention;

FIG. 3 is a fragmented partial half-view in axial section of the hydrokinetic torque-coupling device showing a lock-up clutch and a torsional vibration damper in accordance with the first exemplary embodiment of the present invention;

FIG. 4 is a fragmented partial half-view in axial section of the hydrokinetic torque-coupling device showing the torsional vibration damper in accordance with the first exemplary embodiment of the present invention;

FIG. 5 is fragmented partial half-view in axial section of a turbine wheel and the torsional vibration damper of the hydrokinetic torque-coupling device in accordance with the first exemplary embodiment of the present invention;

FIG. 6 is a fragmented partial half-view in axial section of a locking piston of the hydrokinetic torque-coupling device in accordance with the first exemplary embodiment of the present invention;

FIG. 7A is a perspective view from the left of the locking piston of the hydrokinetic torque-coupling device in accordance with the first exemplary is embodiment of the present invention;

FIG. 7B is a perspective view from the right of the locking piston of the hydrokinetic torque-coupling device in accordance with the first exemplary embodiment of the present invention;

FIG. 8 is a partial perspective view of a torque input member and a radially elastic output member of the torsional vibration damper in accordance with the first exemplary embodiment of the present invention;

FIG. 9 is an elevational view from the rear of a cover plate of the torque input member in accordance with the first exemplary embodiment of the present invention;

FIG. 10 is a perspective view of the radially elastic output member of the torsional vibration damper in accordance with the first exemplary embodiment of the present invention;

FIG. 11 is a partial perspective view from the right of the torsional vibration damper in accordance with the first exemplary embodiment of the present invention;

FIG. 12 is a partial perspective view from the left of the torsional vibration damper in accordance with the first exemplary embodiment of the present invention;

FIG. 13 is a partial perspective view of a torque input member and a radially elastic output member of a torsional vibration damper in accordance with a second exemplary embodiment of the present invention; and

FIG. 14 is a perspective view of a support plate of the torsional vibration damper in accordance with the second exemplary embodiment of the present invention.

FIG. 15 is a fragmented half-view in axial section of a hydrokinetic torque-coupling device in accordance with a third exemplary embodiment of the present invention;

FIG. 16 is an exploded view of partial half-view in axial section of the hydrokinetic torque-coupling device showing the torsional vibration damper in accordance with the third exemplary embodiment of the present invention;

FIG. 17 to FIG. 19 show different positions of a curved elastic blade of a fragmented half-view in axial section of a hydrokinetic torque-coupling device in is accordance with the third exemplary embodiment of the present invention.

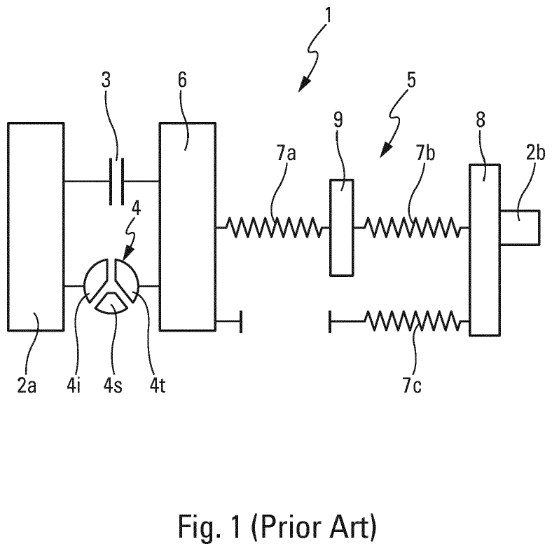

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper”, “lower”, “right”, “left”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly connected together. Additionally, the word “a” and “an” as used in the claims means “at least one” and the word “two” as used in the claims means “at least two”.

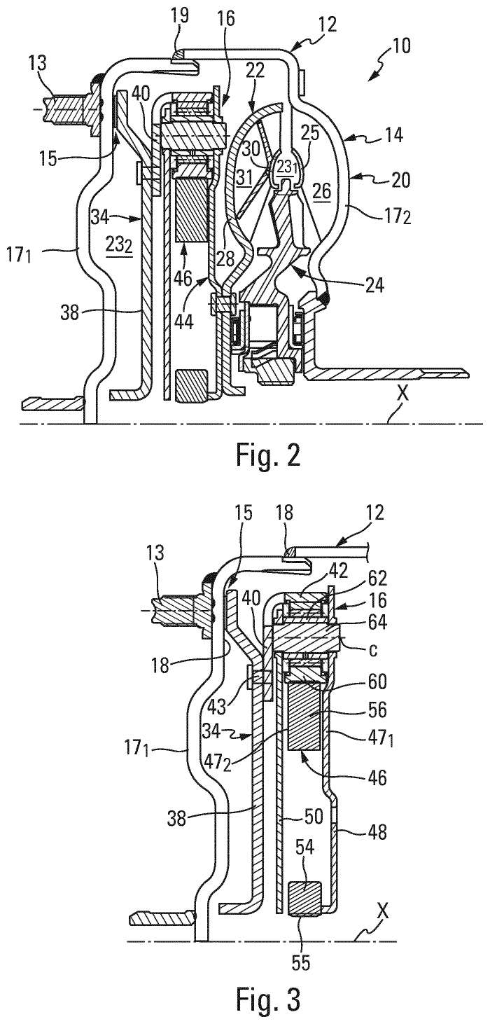

A first exemplary embodiment of a hydrokinetic torque-coupling device is generally represented in FIG. 2 by reference numeral 10. The hydrokinetic torque-coupling device 10 is intended to couple a driving shaft and a driven shaft, for example of a motor vehicle. In this case, the driving shaft is an output shaft of an internal combustion engine (ICE) of the motor vehicle and the driven shaft is a transmission input shaft of an automatic transmission of the motor vehicle.

The hydrokinetic torque-coupling device 10 comprises a sealed casing 12 filled with a fluid, such as oil or transmission fluid, and rotatable about a rotational axis X of rotation, a hydrokinetic torque converter 14 disposed in the casing 12, a lock-up clutch 15 and a torque transmitting device (or torsional vibration damper) 16 also disposed in the casing 12. The torsional vibration damper 16 of the present invention is in the form of a leaf (or blade) damper. The sealed casing 12, the torque converter 14, the lock-up clutch 15 and the torsional vibration damper 16 are all rotatable about the rotational axis X. The drawings discussed herein show half-views, that is, a cross-section of the portion or fragment of the hydrokinetic torque-coupling device 10 above the rotational axis X. As is known in the art, the torque-coupling device 10 is symmetrical about the rotational axis X. Hereinafter the axial and radial orientations are considered with respect to the rotational axis X of the torque-coupling device 10. The relative terms such as “axially,” “radially,” and “circumferentially” are with respect to orientations parallel to, perpendicular to, and circularly around the rotational axis X, respectively.

The sealed casing 12 according to the first exemplary embodiment as illustrated in FIG. 2 includes a first shell (or cover shell) 17₁, and a second shell (or impeller shell) 17₂ disposed coaxially with and axially opposite to the first shell 17₁. The first and second shells 17₁, 17₂ are non-movably (i.e., fixedly) interconnected and sealed together about their outer peripheries, such as by weld 19. The first shell 17₁ is non-movably (i.e., fixedly) connected to the driving shaft, more typically to the output shaft of the ICE, so that the casing 12 turns at the same speed at which the engine operates for transmitting torque. Specifically, in the illustrated embodiment of FIG. 2, the casing 12 is rotatably driven by the ICE and is non-rotatably coupled to the driving shaft thereof, such as with studs 13. Typically, the studs 13 are fixedly secured, such as by welding, to the first shell 17₁. Each of the first and second shells 17₁, 17₂ are one-piece parts, and may be made, for example, by press-forming one-piece metal sheets.

The torque converter 14 comprises an impeller assembly (sometimes referred to as the pump or impeller wheel) 20, a turbine assembly (sometimes referred to as the turbine wheel) 22, and a stator (sometimes referred to as the reactor) 24 interposed axially between the impeller wheel 20 and the turbine wheel 22. The impeller wheel 20, the turbine wheel 22, and the stator 24 are coaxially aligned with one another and the rotational axis X. The impeller wheel 20, the turbine wheel 22, and the stator 24 collectively form a torus. The impeller wheel 20 and the turbine wheel 22 may be fluidly coupled to one another in operation as known in the art.

The impeller wheel 20 includes the substantially annular, semi-toroidal (or concave) impeller shell 17₂, a substantially annular impeller core ring 25, and a plurality of impeller blades 26 fixedly (i.e., non-movably) attached, such as by brazing, to the impeller shell 17₂ and the impeller core ring 25. The impeller wheel 20, including the impeller shell 17₂, the impeller core ring 25 and the impeller blades 26, is non-rotatably secured to the driving shaft (or flywheel) of the ICE to rotate at the same speed as the engine output shaft. The impeller shell 17₂, impeller core ring 25 and the impeller blades 26 are conventionally formed by stamping from steel blanks.

The turbine wheel 22, as best shown in FIG. 2, comprises a substantially annular, semi-toroidal (or concave) turbine shell 28 rotatable about the rotational axis X, a substantially annular turbine core ring 30, and a plurality of turbine blades 31 fixedly (i.e., non-movably) attached, such as by brazing, to the turbine shell 28 and the turbine core ring 30. The turbine shell 28, the turbine core ring 30 and the turbine blades 31 are conventionally formed by stamping from steel blanks.

The lock-up clutch 15 comprises a substantially annular locking piston 34 having an engagement surface 34e facing a locking surface 18 defined on the first shell 17₁ of the casing 12. The locking piston 34 is axially movable along the rotational axis X to and from the locking surface 18 of the first shell 17₁ of the casing 12 so as to selectively engage the locking piston 34 against the locking surface 18 of the casing 12.

The locking piston 34 includes a substantially annular, radially oriented piston plate 38 and a substantially annular connection member 40 non-movably attached (i.e., fixed) to the piston plate 38, as best shown in FIGS. 3-5. Accordingly, the locking piston 34 is an integral (or unitary) part including the piston plate 38 integral with the connection member 40. The connection member 40 includes at least one, preferably a plurality of coupling lugs 42 axially extending from a radially outer peripheral end 41 thereof toward the torsional vibration damper 16 and the turbine shell 28. The connection member 40 with the axially extending coupling lugs 42 is preferably an integral (or unitary) part formed by stamping or press-forming a steel blank or by injection molding of a polymeric material.

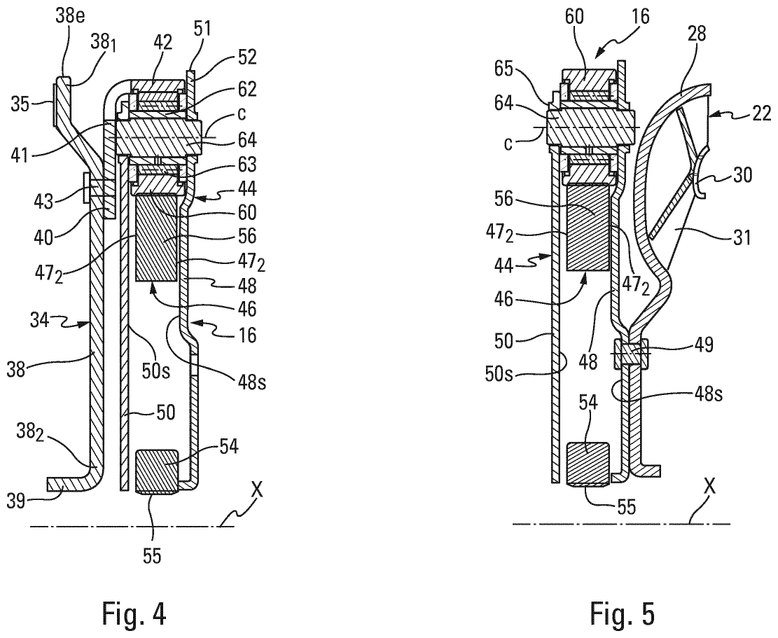

The locking piston 34 according to the exemplary embodiment, including the piston plate 38 and the connection member 40, is an integral (or unitary) part, e.g., is made of two separate components (the piston plate 38 and the connection member 40) fixedly connected together. Specifically, the connection member 40 with the coupling lugs 42 is non-movably attached (i.e., fixed) to the piston plate 38 by appropriate means, such as by welding, adhesive bonding or fasteners, such as rivets 43, as best shown in FIG. 4. In other words, the coupling lugs 42 are non-movably attached to the piston plate 38. Those skilled in the art should understand that the term “non-movably connected” (or “non-movably attached”) means that the locking piston 34 or other assembly is made of separate components fixedly (i.e., non-movably) connected together, such as by rivets, weldment, adhesives, or the like, or a part made as a single-piece component (i.e., made as a single-piece part), such as by casting, forging, press forming, or the like. Thus, alternatively, the locking piston 34 may be formed as a single-piece part with the piston plate 38 and the coupling lugs 42 by stamping or press-forming a steel blank or by injection molding of a polymeric material.

The engagement surface 34e is disposed at a radially outer peripheral end 38₁ of the piston plate 38, as best shown in FIG. 4. Moreover, extending axially at a radially inner peripheral end 38₂ of the piston plate 38 is a substantially cylindrical flange 39 that is proximate to and coaxial with the rotational axis X, as best shown in FIGS. 2-5. The cylindrical flange 39 of the piston plate 38 of the locking piston 34 is mounted to the driven shaft so as to be centered on, rotatable with and axially slidably displaceable relative to the driven shaft. As discussed in further detail below, the locking piston 34 is axially movable relative to the driven shaft. The axial motion of the locking piston 34 along the driven shaft is controlled by torus and damper pressure chambers 23₁ and 23₂, respectively, positioned on axially opposite sides of the locking piston 34.

The lock-up clutch 15 further includes an annular friction liner 35 (best shown in FIG. 4) fixedly attached to the engagement surface 34e of the piston plate 38 of the locking piston 34 by appropriate means known in the art, such as by adhesive bonding. As best shown in FIGS. 2-5, the friction liner 35 is fixedly attached to the engagement surface 34e of the locking piston 34 at the radially outer peripheral end 38₁ of the piston plate 38. The annular friction liner 35 is made of a friction material for improved frictional performance. Alternatively, an annular friction liner may be secured to the locking surface 18 of the casing 12. According to still another embodiment, a first friction ring or liner is secured to the locking surface 18 of the casing 12 and a second friction ring or liner is secured to the engagement surface 34e of the locking piston 34. It is within the scope of the invention to omit one or both of the friction rings. In other words, the annular friction liner 35 may be secured to any, all, or none of the engagement surfaces. Furthermore, according to the exemplary embodiment the engagement surface 34e of the locking piston 34 is slightly conical to improve the engagement of the lock-up clutch 15. Specifically, the engagement surface 34e of the piston plate 38 holding the annular friction liner 35 is conical, at an angle between 10° and 30°, to improve the torque capacity of the lock-up clutch 15. Alternatively, the engagement surface 34e of the piston plate 38 may be parallel to the locking surface 18 of the casing 12.

The lock-up clutch 15 is provided for locking the driving and driven shafts. The lock-up clutch 15 is usually activated after starting of the motor vehicle and after hydraulic coupling of the driving and driven shafts, in order to avoid the loss of efficiency caused in particular by slip phenomena between the impeller wheel 20 and the turbine wheel 22. The locking piston 34 is axially displaceable toward (an engaged (or locked) position of the lock-up clutch 15) and away (a disengaged (or open) position of the lock-up clutch 15) from the locking surface 18 inside the casing 12. Moreover, the locking piston 34 is axially displaceable away from (the engaged (or locked) position of the lock-up clutch 15) and toward (the disengaged (or open) position of the lock-up clutch 15) the torsional vibration damper 16.

The locking piston 34 is selectively pressed against the locking surface 18 of the casing 12 so as to lock-up the torque-coupling device 10 between the driving shaft and the driven shaft to control sliding movement between the turbine wheel 22 and the impeller wheel 20. Specifically, when an appropriate hydraulic pressure in applied to the locking piston 34, the locking piston 34 moves rightward (as shown in FIG. 2) toward the locking surface 18 of the casing 12 and away from the turbine wheel 22, and clamps the friction liner 35 between itself and the locking surface 18 of the casing 12. As a result, the lock-up clutch 15 in the locked position is mechanically frictionally coupled (or locked) to the casing 12. Thus, the lock-up clutch 15 is provided to bypass the turbine wheel 22 when in the locked position thereof.

During operation, when the lock-up clutch 15 is in the disengaged (open) position, the engine torque is transmitted from the impeller wheel 20 by the turbine wheel 22 of the torque converter 14 to the driven shaft through the torsional vibration damper 16. When the lock-up clutch 15 is in the engaged (locked) position, the engine torque is transmitted by the casing 12 to the driven shaft also through the torsional vibration damper 16.

The torsional vibration damper 16 advantageously allows the turbine wheel 22 of the torque converter 14 to be coupled, with torque damping, to the driven shaft, i.e., the input shaft of the automatic transmission. The torsional vibration damper 16 also allows damping of stresses between the driving shaft and the driven shaft that are coaxial with the rotational axis X, with torsion damping.

The torsional vibration damper 16, as best shown in FIG. 2, is disposed axially between the turbine shell 28 of the turbine wheel 22, and the locking piston 34 of the lock-up clutch 15. The locking piston 34 of the lock-up clutch 15 is rotatably and axially slidably mounted to the driven shaft. The torsional vibration damper 16 is positioned on the driven shaft in a limited, movable and centered manner. The locking piston 34 forms an input part of the torsional vibration damper 16.

The torsional vibration damper 16 comprises a torque input member 44 rotatable about the rotational axis X, and an integral radially elastic output member 46 elastically coupled to and configured to pivot (i.e., rotate) relative to the torque input member 44 around the rotational axis X. The torque input member 44 includes an annular, radially oriented cover plate 48 adjacent to the turbine shell 28, at least one, preferably two supporting members 60, and a support plate 50 disposed axially opposite the cover plate 48 and adjacent to the piston plate 38, as best shown in FIG. 4. The cover plate 48 is axially spaced from the piston plate 38 and houses the output member 46 axially therebetween. The piston plate 38 is substantially parallel to and axially spaced from the cover plate 48, as best shown in FIG. 4. Moreover, the piston plate 38 and the cover plate 48 are non-rotatably coupled to one another, such as by the coupling lugs 42. At the same time, the locking piston 34 (i.e., the piston plate 38 with the integral coupling lugs 42) is axially movable relative to the cover plate 48. Thus, the piston plate 38 and the cover plate 48 are non-rotatable relative to one another, but rotatable relative to the radially elastic output member 46. Moreover, the locking piston 34 is axially movable relative to the cover plate 48. Furthermore, the cover plate 48 is non-movably attached (i.e., fixed) to the turbine shell 28, for example by welding or by fasteners, such as rivets 49, as best shown in FIG. 5. The support plate 50 is non-rotatably coupled to the cover plate 48. According to the first exemplary embodiment of the present invention, as best illustrated in FIG. 8, the support plate 50 is in the form of a rectangular flat (or planar) plate. As best shown in FIG. 4, the support plate 50 is disposed between the piston plate 38 and the cover plate 48. Moreover, the rectangular support plate 50 does not entirely cover the radially elastic output member 46 in the axial direction, as best shown in FIG. 8.

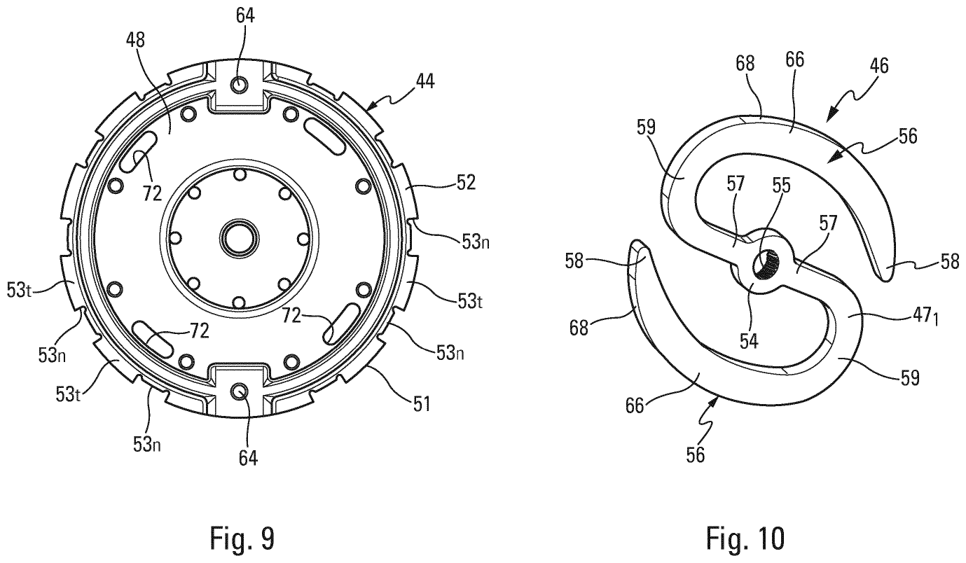

According to the exemplary embodiment of the present invention, as best illustrated in FIGS. 8 and 9, the cover plate 48 has a substantially annular radially outer flange 52. The outer flange 52 of the cover plate 48 includes at least one, preferably a plurality, of notches (or recesses) 53n, each complementary to one of the coupling lugs 42. Specifically, the notches 53n are provided in the radially outer flange 52 of the cover plate 48, as best shown in FIGS. 8 and 9. The notches 53n are separated from each other by radially outwardly extending cogs (or teeth) 53t defining the notches 53n therebetween. Each of the coupling lugs 42 positively engages one of the complementary notches 53n so as to non-rotatably couple the locking piston 34 and the cover plate 48 while allowing an axial motion of the locking piston 34 with respect to the cover plate 48, as best shown in FIGS. 2-4.

In the exemplary embodiment, the supporting members 60 are in the form of annular rolling bodies, such as cylindrical rollers rotatably mounted to radially external peripheries of the cover plate 48 and the support plates 50, axially between the cover plate 48 and the support plate 50, as best shown in FIG. 8. Each of the rolling bodies 60 is rotatable around a central axis C. The central axis C of each rolling body 60 is substantially parallel to the rotational axis X, as best shown in FIGS. 3 and 4. The rolling bodies 60 are positioned so as to be diametrically opposite to one another. More specifically, the rolling bodies 60 are rotatably mounted about hollow shafts 62, which axially extend between the cover plate 48 and the support plate 50. The hollow shafts 62 are mounted on support pins 64 extending axially through the hollow shafts 62 and between the cover plate 48 and the support plate 50, as best shown in FIGS. 3 and 4. Thus, the support plate 50 provides dimensional stability of the support pins 64. Moreover, the support pins 64 non-rotatably couple the cover plate 48 to the support plate 50 of the torque input member 44. A C-ring 65, best shown in FIGS. 5 and 8, retains the support plate 50 on the support pin 64 in the direction away from the cover plate 48 and the rolling body 60. Thus, the support plate 50 is non-movably secured to the cover plate 48. The rolling bodies 60 are rotatably mounted on the hollow shafts 62 through rolling bearings, such as needle bearings 63, for instance, as best shown in FIG. 4. In other words, the rolling bodies 60 are rotatable around the central axes C, while the support pins 64 are non-movable relative to the cover plate 48 and the support plate 50 of the torque input member 44.

The radially elastic output member 46 includes an annular output hub 54 coaxial with the rotational axis X and rotatable relative the torque input member 44, and at least one and preferably two substantially identical, radially opposite curved elastic blades (or leaves) 56 non-movably connected to (i.e., integral with) the output hub 54, as best shown in FIG. 10. The radially elastic output member 46 is made of steel by fine stamping and heat treatment. According to the exemplary embodiment of the present invention, the radially elastic output member 46, including the output hub 54 and the elastic blades 56, is made as a single-piece part.

The radially elastic output member 46 is configured to elastically and radially engage the rolling bodies 60 and to elastically bend in the radial direction upon rotation of the torque input member 44 with respect to the radially elastic output member 46. A radially inner surface of the output hub 54 includes splines 55 for directly and non-rotatably engaging complementary splines of the driven shaft. At the same time, the output hub 54 of the radially elastic output member 46 is axially movable relative to the driven shaft due to a splined connection therebetween. Accordingly, the radially elastic output member 46 is non-rotatably coupled to and axially movable relative to the driven shaft.

As best shown in FIG. 10, each of the curved elastic blades 56 is symmetrical with respect to the rotational axis X. Moreover, each of the curved elastic blades 56 has a proximal end 57 non-movably connected (i.e., fixed) to the output hub 54, a free distal end 58, a bent portion 59 adjacent to the proximal end 57, and a curved raceway portion 66 disposed adjacent to free distal end 58 of the elastic blade 56 for bearing one of the rolling bodies 60. Also, the curved raceway portion 66 is connected to the output hub 54 by the bent portion 59. The radially elastic output member 46 with the output hub 54 and the elastic blades 56 is preferably an integral (or unitary) component, e.g., made of a single part, but may be separate components fixedly connected together.

Each of the curved elastic blades 56 and each of the bent portions 59 are elastically deformable. The bent portion 59 subtends an angle of approximately 180°. A radially external surface of the curved raceway portion 66 of each of the curved elastic blades 56 defines a radially outer raceway 68 configured as a surface that is in a rolling contact with one of the rollers 60, so that each of the rolling bodies 60 is positioned radially outside of the elastic blade 56, as illustrated in FIGS. 2-4 and 6. The raceways 68 of the curved raceway portions 66 of the curved elastic blade 56 extend on a circumference with an angle ranging from about 90° to about 180°. The raceway 68 of each of the curved raceway portions 66 has a generally convex shape, as best shown in FIG. 10. Moreover, as the torque input member 44 is rotatably movable around the rotational axis X relative to the radially elastic output member 46, the rolling bodies 60 are angularly (or circumferentially) displaceable relative to and over the raceways 68 of the curved raceway portions 66 of the curved elastic blades 56.

As best shown in FIGS. 3-5 and 8, the curved elastic blades 56 of the radially elastic output member 46 and the rolling bodies 60 are disposed radially within a radially outer edge 51 of the cover plate 48 and a radially outer edge 38e of the piston plate 38. In other words, the radially elastic output member 46 and the rolling bodies 60 are entirely or almost entirely covered by the piston plate 38 and the cover plate 48 in the axial direction. In fact, the cover plate 48 covers 70% to 100% (i.e., at least partially or no less than 70%) of an area of an axially first outer surface 47₁ of the radially elastic output member 46 that faces the cover plate 48. Moreover, the curved elastic blades 56 of the radially elastic output member 46 are disposed radially within the coupling lugs 42 of the locking piston 34.

Furthermore, as best illustrated in FIG. 8, the support plate 50 does not entirely cover the radially elastic output member 46 in the axial direction. In fact, the support plate 50 covers 5% to 30% (i.e., partially or no more than 30%) of an area of an axially second outer surface 47₂ of the radially elastic output member 46 that faces the support plate 50. Moreover, not all, in fact most, of the curved elastic blades 56 of the radially elastic output member 46 and the rolling bodies 60 are disposed radially within a radially outer edge 50e of the support plate 50, as best shown in FIG. 8. Therefore, the radially elastic output member 46 and the rolling bodies 60 are entirely or almost entirely covered in the axial direction (i.e., from axially opposite sides) only by the piston plate 38 and the cover plate 48. Furthermore, an area of an axially outer surface 50s of the support plate 50 facing the radially elastic output member 46 is between 40% to 95% less (i.e., at least 40% less) than the area of an axially outer surface 48s of the cover plate 48 facing the radially elastic output member 46.

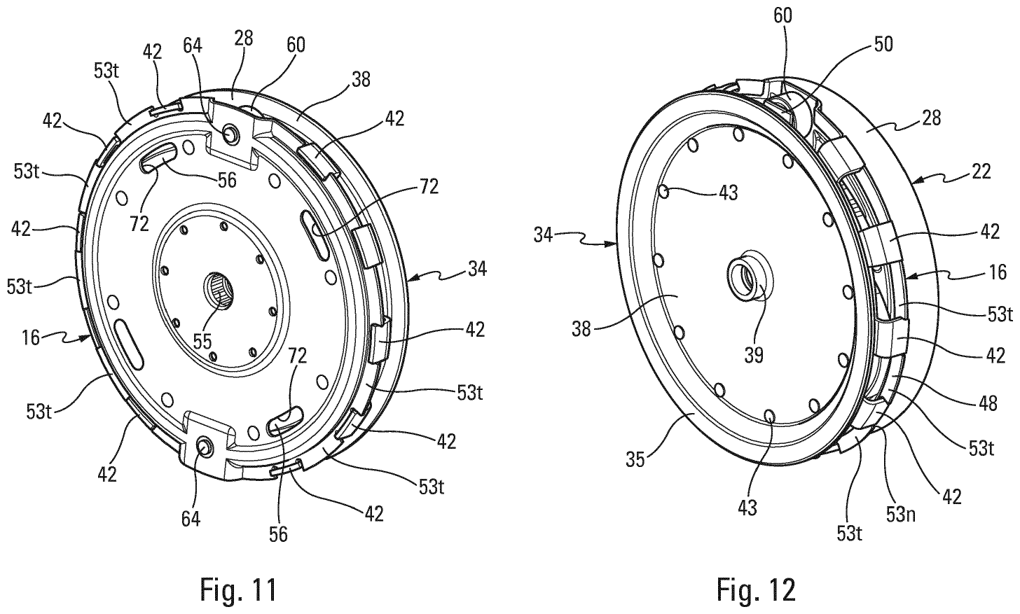

The cover plate 48 of the torsional vibration damper 16 is formed with at least one, preferably a plurality of viewing windows 72 therethrough, as best shown in FIGS. 8, 9 and 11. In the exemplary embodiment of the present invention, the cover plate 48 of the torsional vibration damper 16 is formed with four (4) viewing windows 72, which are circumferentially spaced from each other around the rotational axis X, as best shown in FIGS. 9 and 11. As best shown in FIGS. 8 and 11, the viewing windows 72 are configured to expose a portion of the radially elastic output member 46 of the torsional vibration damper 16, and to allow one determine how the curved elastic blades 56 of the radially elastic output member 46 are angularly oriented, i.e., whether the curved elastic blades 56 extend in the circumferential direction clockwise or counterclockwise around the rotational axis X. In other words, the viewing windows 72 allow an interior space between the piston plate 38 of the locking piston 34 and the cover plate 48 of the torsional vibration damper 16 to be observed.

The lock-up clutch 15 is configured to non-rotatably couple the casing 12 and the torque input member 44 in the engaged (locked) position, and configured to drivingly disengage the casing 12 and the torque input member 44 in the disengaged (open) position.

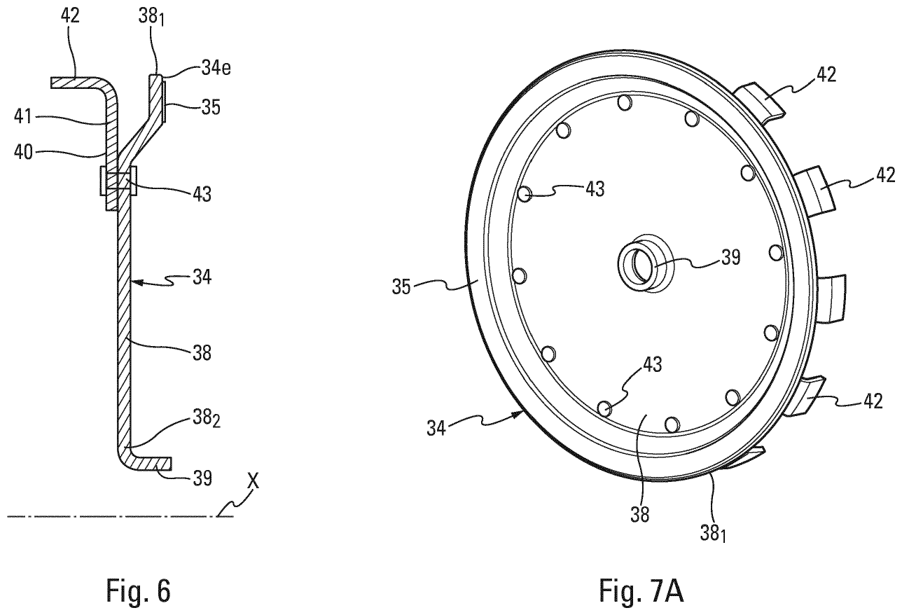

In operation, when each rolling body 60 moves along the raceway 68 of the curved raceway portion 66 of the curved elastic blade 56, the rolling body 60 presses the curved raceway portion 66 of the curved elastic blade 56 radially inwardly, thus maintaining contact of the rolling body 60 with the curved raceway portion 66 of the curved elastic blade 56, as illustrated in FIGS. 3 and 6. Radial forces cause the curved elastic blades 56 to bend, and forces tangential to the raceways 66 of the curved elastic blades 56 allow each rolling body 60 to move (roll) on the raceway 68 of the associated curved elastic blade 56, and to transmit torque from the torque input member 44 to the output hub 54 of the elastic output member 46, and then to the driven shaft. Thus, the output hub 54 of the radially elastic output member 46, which is splined directly to the driven shaft, forms an output part of the torsional vibration damper 16 and a driven side of the torque-coupling device 10. The locking piston 34, on the other hand, forms an input part of the torsional vibration damper 16. The torque from the driving shaft (or crankshaft) is transmitted to the casing 12 through the studs 13.

In the disengaged position of the lock-up clutch 15, torque flows through the torque converter 14, i.e. the impeller wheel 20 and then the turbine wheel 22 fixed to the torque input member 44 of the torsional vibration damper 16. The torque is then transmitted to the driven shaft (transmission input shaft) splined directly to the radially elastic output member 46 of the torsional vibration damper 16.

In the engaged position of the lock-up clutch 15, torque from the casing 12 is transmitted to the torque input member 44 (i.e., the piston plate 38, the cover plate 48, the support plate 50, and the rolling bodies 60) through the elastic output member 46 formed by the output hub 54 and the elastic blades 56. The torque is then transmitted from the output hub 54 of the radially elastic output member 46 to the driven shaft (transmission input shaft) splined to the output hub 54. Moreover, when the torque transmitted between the casing 12 and the output hub 54 of the radially elastic output member 46 varies, the radial forces exerted between each of the elastic blades 56 and the corresponding rolling bodies 60 vary and bending of the elastic blades 56 is accordingly modified. The modification in the bending of the elastic blade 56 comes with motion of the rolling body 60 along the corresponding raceway 68 of the curved elastic blade 56.

Each of the raceways 68 has a profile so arranged that, when the transmitted torque increases, the rolling body 60 exerts a bending force on the corresponding curved elastic blade 56, which causes the free distal end 58 of the curved elastic blade 56 to move radially towards the rotational axis X and produces a relative rotation between the casing 12 and the output hub 54 of the radially elastic output member 46. As a result, both the casing 12 and the output hub 54 move away from their relative rest positions. A rest position is that position of the torque input member 44 relative to the radially elastic output member 46, wherein no torque is transmitted between the casing 12 and the output hub 54 of the radially elastic output member 46 through the rolling bodies 60.

The profiles of the raceways 68 are such that the rolling bodies 60 exert bending forces (pressure) having radial and circumferential components onto the curved elastic blades 56. Specifically, the elastic blades 56 are configured so that in a relative angular position between the torque input member 44 and the elastic output member 46 different from the rest position, each of the rolling bodies 60 exerts a bending force on the corresponding elastic blade 56, thus causing a reaction force of the elastic blade 56 acting on the rolling body 60, with the reaction force having a radial component which tends to maintain the elastic blade 56 in contact with the rolling body 60.

In turn, each of the elastic blades 56 exerts on the corresponding rolling body 60 a back-moving force having a circumferential component which tends to rotate the rolling bodies 60 in a reverse direction of rotation, and thus to move the torque input member 44 (thus, the turbine wheel 22) and the output hub 54 of the radially elastic output member 46 back towards their relative rest positions, and a radial component directed radially outwardly, which tends to maintain each of the raceways 68 in direct contact with the corresponding rolling body 60.

When the casing 12 and the radially elastic output member 46 are in the rest position, the elastic blades 56 are preferably radially pre-stressed toward the rotational axis X so as to exert a reaction force directed radially outwards, to thus maintain the curved elastic blades 56 supported by the associated rolling bodies 60. Moreover, the profiles of the raceways 68 are so configured that a characteristic transmission curve of torque according to the angular displacement of the rolling body 60 relative to the raceway 68 is symmetrical or asymmetrical relative to the rest position. According to the exemplary embodiment, the angular displacement of each rolling body 60 relative to the raceway 68 is more important in a direct direction of rotation than in a reverse (i.e., opposite to the direct) direction of rotation.

According to the exemplary embodiment, the angular displacement of the casing 12 relative to the radially elastic output member 46 in the locked position of the lock-up clutch 15 is greater than 20°, preferably greater than 40°. The curved elastic blades 56 are regularly distributed around the rotational axis X and are symmetrical relative to the rotational axis X so as to ensure the balance of the torque converter 14.

A method for assembling the hydrokinetic torque-coupling device 10 is as follows. First, the impeller wheel 20, the turbine wheel 22, the stator 24, and the torsional vibration damper 16 may each be preassembled. The impeller wheel 20 and the turbine wheel 22 are formed by stamping from steel blanks or by injection molding of a polymeric material. The stator 24 is made by casting from aluminum or injection molding of a polymeric material. The impeller wheel 20, the turbine wheel 22 and the stator 24 subassemblies are assembled together so as to form the torque converter 14.

The torsional vibration damper 16 is then added. The cover plate 48 and the support plate 50 are formed by stamping from a steel blank. Before the torque converter 14 and the torsional vibration damper 16 are assembled, the turbine shell 28 of the turbine wheel 22 is non-movably attached (i.e., fixed) to the cover plate 48 of the torque input member 44 of the torsional vibration damper 16, for example by welding or by fasteners, such as the rivets 49, as best shown in FIG. 5.

The locking piston 34 is then added. The piston plate 38 and the connection member 40 with the integral coupling lugs 42 are formed by stamping from a steel blank. The connection member 40 is non-movably attached (i.e., fixed) to the piston plate 38 of the locking piston 34, for example by welding or by fasteners, such as the rivets 43, as best shown in FIG. 6. Next, the locking piston 34 is mounted to the torsional vibration damper 16 so that the locking piston 34 non-rotatably engages the torque input member 44 of the torsional vibration damper 16. Specifically, the coupling lugs 42 of the locking piston 34 non-rotatably engage the complementary notches 53n of the cover plate 48 so as to non-rotatably couple the locking piston 34 with the cover plate 48 of the torsional vibration damper 16 while allowing an axial motion of the locking piston 34 with respect to the cover plate 48.

Then, the cover shell 17₁ is non-movably and sealingly secured, such as by welding at 19, to the impeller shell 17₂, as best shown in FIG. 2. After that, the torque-coupling device 10 is mounted to the driven shaft (i.e., the input shaft of the automatic transmission of the motor vehicle) so that the output hub 54 of the elastic output member 46 of the torsional vibration damper 16 is splined directly to the transmission input shaft and the cylindrical flange 39 of the locking piston 34 is slidably mounted over the transmission input shaft.

It should be understood that this exemplary method may be practiced in connection with the other embodiments described herein. This exemplary method is not the exclusive method for assembling the turbine assembly described herein. While the methods for assembling the hydrokinetic torque-coupling device 10 may be practiced by sequentially performing the steps as set forth below, it should be understood that the methods may involve performing the steps in different sequences.

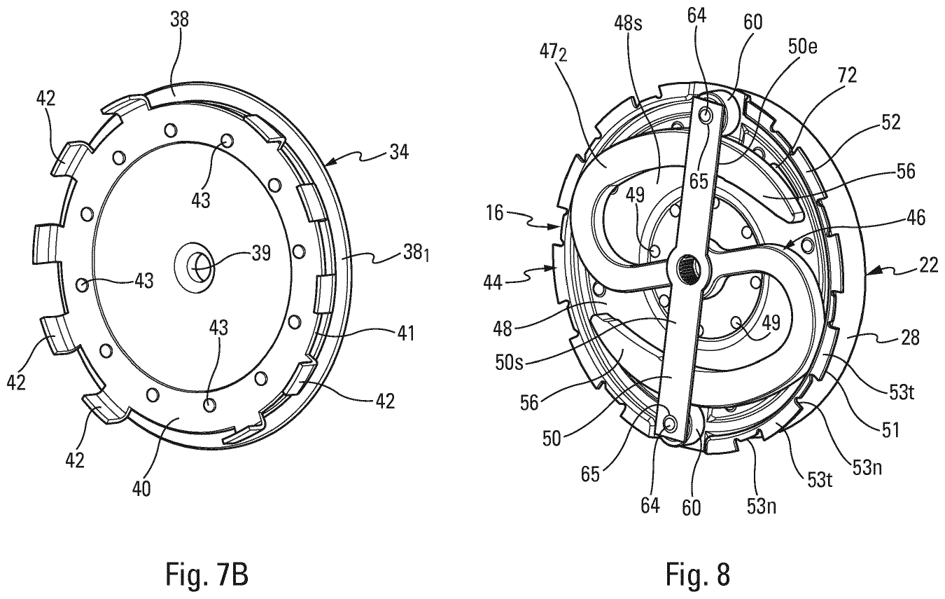

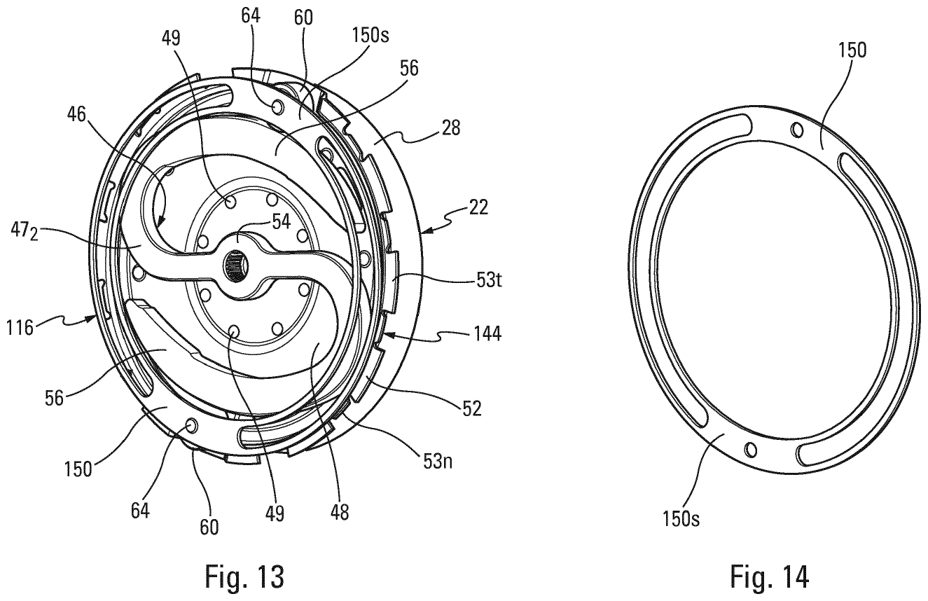

Various modifications, changes, and alterations may be practiced with the above-described embodiment, including but not limited to the additional embodiment shown in FIGS. 13-14. In the interest of brevity, reference characters in FIGS. 13-14 that are discussed above in connection with FIGS. 2-12 are not further elaborated upon below, except to the extent necessary or useful to explain the additional embodiment of FIGS. 13-14. Modified components and parts are indicated by the addition of a hundred digits to the reference numerals of the components or parts.

In a hydrokinetic torque-coupling device 110 of a second exemplary embodiment illustrated in FIGS. 13-14, the torsional vibration damper 16 is replaced by a torsional vibration damper 116. The hydrokinetic torque-coupling device 110 of FIGS. 13-14 corresponds substantially to the hydrokinetic torque-coupling device 10 of FIGS. 2-12, and the torsional vibration damper 116 will be explained in detail below.

The torsional vibration damper 116 comprises a torque input member 144 rotatable about the rotational axis X, and an integral radially elastic output member 46 elastically coupled to and configured to pivot (i.e., rotate) relative to the torque input member 144 around the rotational axis X. The torque input member 144 includes an annular, radially oriented cover plate 48 adjacent to the turbine shell 28, at least one, preferably two supporting members 60, and a support plate 150 disposed axially opposite the cover plate 48, as best shown in FIG. 13. In the exemplary embodiment, the supporting members 60 are in the form of annular rolling bodies, such as cylindrical rollers rotatably mounted to radially external peripheries of the cover plate 48 and the support plates 150, axially between the cover plate 48 and the support plate 150. Each of the rolling bodies 60 is rotatable around a central axis C. The support plate 150 is non-rotatably coupled to the cover plate 48. According to the second exemplary embodiment of the present invention, as best illustrated in FIGS. 13 and 14, the support plate 150 is in the form of an annular flat (or planar) plate. Moreover, the annular support plate 150 does not entirely cover the radially elastic output member 46 in the axial direction, as best shown in FIG. 13.

According to the exemplary embodiment of the present invention, as best illustrated in FIG. 13, the support plate 150 does not entirely cover the radially elastic output member 46 in the axial direction. In fact, the support plate 150 covers 5% to 30% (i.e., no more than 30%) of the area of the axially second outer surface 47₂ of the radially elastic output member 46 that faces the support plate 150. Furthermore, an area of an axially outer surface 150s of the support plate 150 facing the radially elastic output member 46 is between 40% to 95% less (i.e., at least 40% less) than the area of the axially outer surface 48s of the cover plate 48 facing the radially elastic output member 46.

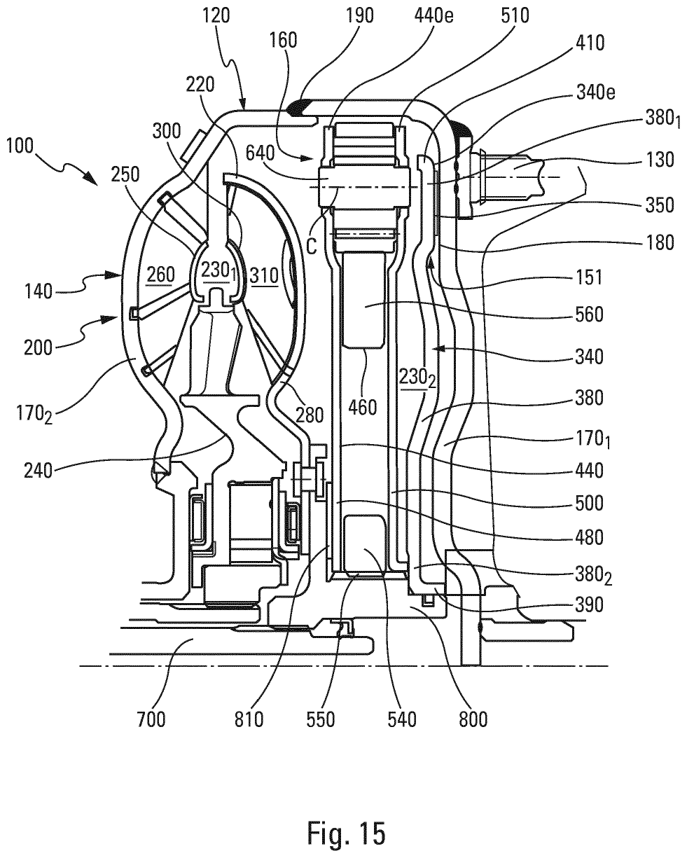

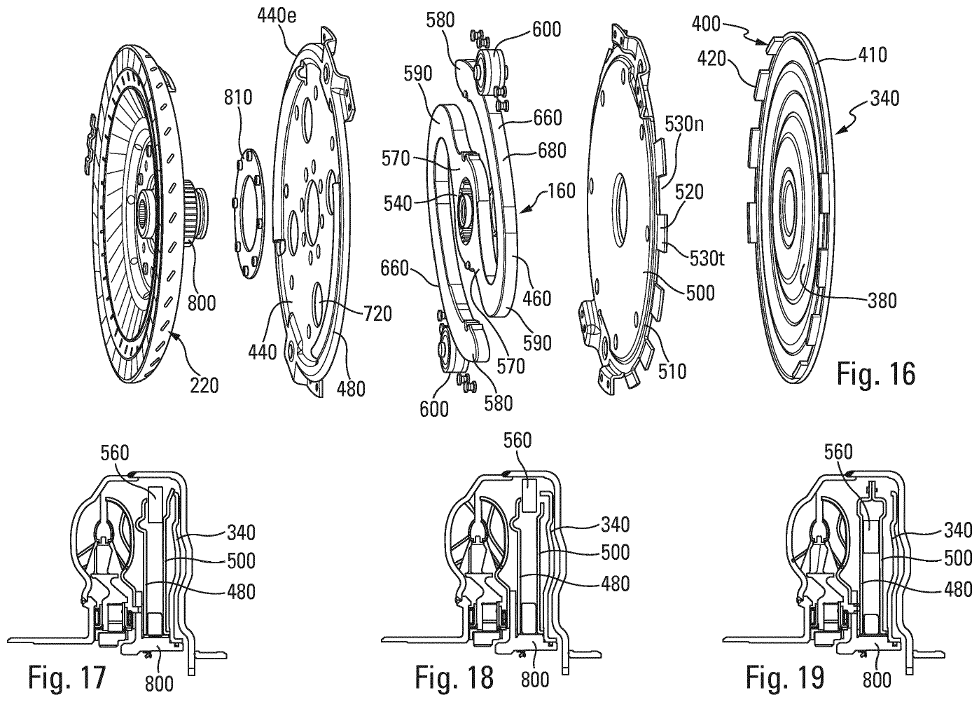

A third exemplary embodiment of a hydrokinetic torque-coupling device is generally represented in FIG. 15 by reference numeral 100. The hydrokinetic torque-coupling device 100 is intended to couple a driving shaft (not illustrated) and a driven shaft 700, for example of a motor vehicle. In this case, the driving shaft is an output shaft of an internal combustion engine (ICE) of the motor vehicle and the driven shaft is a transmission input shaft of an automatic transmission of the motor vehicle.

The hydrokinetic torque-coupling device 100 comprises a sealed casing 120 filled with a fluid, such as oil or transmission fluid, and rotatable about a rotational axis X of rotation, a hydrokinetic torque converter 140 disposed in the casing 120, a lock-up clutch 151 and a torque transmitting device (or torsional vibration damper) 160 also disposed in the casing 120. The torsional vibration damper 160 of the present invention is in the form of a leaf (or blade) damper. The sealed casing 120, the torque converter 140, the lock-up clutch 151 and the torsional vibration damper 160 are all rotatable about the rotational axis X. The drawings discussed herein show half-views, that is, a cross-section of the portion or fragment of the hydrokinetic torque-coupling device 100 above the rotational axis X. As is known in the art, the torque-coupling device 100 is symmetrical about the rotational axis X. Hereinafter the axial and radial orientations are considered with respect to the rotational axis X of the torque-coupling device 100. The relative terms such as “axially,” “radially,” and “circumferentially” are with respect to orientations parallel to, perpendicular to, and circularly around the rotational axis X, respectively.

The sealed casing 120 according to the first exemplary embodiment as illustrated in FIG. 2 includes a first shell (or cover shell) 170₁, and a second shell (or impeller shell) 170₂ disposed coaxially with and axially opposite to the first shell 170₁. The first and second shells 170₁, 170₂ are non-movably (i.e., fixedly) interconnected and sealed together about their outer peripheries, such as by weld 190. The first shell 170₁ is non-movably (i.e., fixedly) connected to the driving shaft, more typically to the output shaft of the ICE, so that the casing 120 turns at the same speed at which the engine operates for transmitting torque. Specifically, in the illustrated embodiment of FIG. 15, the casing 120 is rotatably driven by the ICE and is non-rotatably coupled to the driving shaft thereof, such as with studs 130. Typically, the studs 130 are fixedly secured, such as by welding, to the first shell 170₁. Each of the first and second shells 170₁, 170₂ are one-piece parts, and may be made, for example, by press-forming one-piece metal sheets.

The torque converter 140 comprises an impeller assembly (sometimes referred to as the pump or impeller wheel) 200, a turbine assembly (sometimes referred to as the turbine wheel) 220, and a stator (sometimes referred to as the reactor) 240 interposed axially between the impeller wheel 200 and the turbine wheel 220. The impeller wheel 200, the turbine wheel 220, and the stator 240 are coaxially aligned with one another and the rotational axis X. The impeller wheel 200, the turbine wheel 202, and the stator 240 collectively form a torus. The impeller wheel 200 and the turbine wheel 220 may be fluidly coupled to one another in operation as known in the art.

The impeller wheel 200 includes the substantially annular, semi-toroidal (or concave) impeller shell 170₂, a substantially annular impeller core ring 250, and a plurality of impeller blades 260 fixedly (i.e., non-movably) attached, such as by is brazing, to the impeller shell 170₂ and the impeller core ring 250. The impeller wheel 200, including the impeller shell 170₂, the impeller core ring 250 and the impeller blades 260, is non-rotatably secured to the driving shaft (or flywheel) of the ICE to rotate at the same speed as the engine output shaft. The impeller shell 170₂, impeller core ring 250 and the impeller blades 260 are conventionally formed by stamping from steel blanks.

The turbine wheel 220, as best shown in FIG. 15, comprises a substantially annular, semi-toroidal (or concave) turbine shell 280 rotatable about the rotational axis X, a substantially annular turbine core ring 300, and a plurality of turbine blades 310 fixedly (i.e., non-movably) attached, such as by brazing, to the turbine shell 280 and the turbine core ring 300. The turbine shell 280, the turbine core ring 300 and the turbine blades 310 are conventionally formed by stamping from steel blanks.

The lock-up clutch 151 comprises a substantially annular locking piston 340 having an engagement surface 340e facing a locking surface 180 defined on the first shell 170₁ of the casing 120. The locking piston 340 is axially movable along the rotational axis X to and from the locking surface 180 of the first shell 170₁ of the casing 120 so as to selectively engage the locking piston 340 against the locking surface 180 of the casing 120.

The locking piston 340 includes a substantially annular, radially oriented piston plate 380 and a substantially annular connection member 400 non-movably attached (i.e., fixed) to the piston plate 380, as best shown in FIG. 16. This connection member 400 is not visible in the FIG. 15 but on the FIG. 16. This connection member 400 forms one part with the piston plate 380 but could form a separate element attached fixedly to the piston plate 380. The connection member 400 forms outer radial coupling lugs 420 on the peripheriy of the piston plate 380. Accordingly, the locking piston 340 is an integral (or unitary) part including the piston plate 380 integral with the connection member 400. The connection member 400 includes at least one, preferably a plurality of coupling lugs 420 axially extending from a radially outer peripheral end 410 thereof toward the torsional vibration damper 160 and the turbine shell 280. The connection member 400 with the axially extending coupling lugs 420 is preferably an integral (or unitary) part formed by stamping or press-forming a steel blank or by injection molding of a polymeric material.

Here the locking piston 340 is formed as a single-piece part with the piston plate 380 and the coupling lugs 420.

The engagement surface 340e is disposed at a radially outer peripheral end 380₁ of the piston plate 380, as best shown in FIG. 15. Moreover, extending axially at a radially inner peripheral end 380₂ of the piston plate 380 is a substantially cylindrical flange 390 that is proximate to and coaxial with the rotational axis X, as best shown in FIG. 15. The cylindrical flange 390 of the piston plate 380 of the locking piston 340 is mounted to the driven shaft via a turbine hub 800. The locking piston 340 is centered on this turbine hub 800 and rotatable with and axially slidably displaceable relative to the turbine hub 800. The turbine hub 800 is non rotatably linked to the turbine wheel 220 and to the driven shaft 700. As discussed in further detail below, the locking piston 340 is axially movable relative to the turbine hub 800. The axial motion of the locking piston 340 along the turbine hub 800 is controlled by torus and damper pressure chambers 230₁ and 230₂, respectively, positioned on axially opposite sides of the locking piston 340.

The lock-up clutch 151 further includes an annular friction liner 350 (best shown in FIG. 15) fixedly attached to the engagement surface 340e of the piston plate 380 of the locking piston 340 by appropriate means known in the art, such as by adhesive bonding. The friction liner 350 is fixedly attached to the engagement surface 340e of the locking piston 340 at the radially outer peripheral end 380₁ of the piston plate 380. The annular friction liner 350 is made of a friction material for improved frictional performance. Alternatively, an annular friction liner may be secured to the locking surface 180 of the casing 120. According to still another embodiment, a first friction ring or liner is secured to the locking surface 180 of the casing 120 and a second friction ring or liner is secured to the engagement surface 340e of the locking piston 340. It is within the scope of the invention to omit one or both of the friction rings. In other words, the annular friction liner 350 may be secured to any, all, or none of the engagement surfaces. Furthermore, according to the exemplary embodiment the engagement surface 340e of the locking piston 340 is slightly conical to improve the engagement of the lock-up clutch 151. Specifically, the engagement surface 340e of the piston plate 380 holding the annular friction liner 350 is conical, at an angle between 10° and 30°, to improve the torque capacity of the lock-up clutch 151. Alternatively, the engagement surface 340e of the piston plate 380 may be parallel to the locking surface 180 of the casing 120.

The lock-up clutch 151 is provided for locking the driving and driven shafts. The lock-up clutch 151 is usually activated after starting of the motor vehicle and after hydraulic coupling of the driving and driven shafts, in order to avoid the loss of efficiency caused in particular by slip phenomena between the impeller wheel 200 and the turbine wheel 220. The locking piston 340 is axially displaceable toward (an engaged (or locked) position of the lock-up clutch 151) and away (a disengaged (or open) position of the lock-up clutch 151) from the locking surface 180 inside the casing 120. Moreover, the locking piston 340 is axially displaceable away from (the engaged (or locked) position of the lock-up clutch 151) and toward (the disengaged (or open) position of the lock-up clutch 15) the torsional vibration damper 16.

The locking piston 340 is selectively pressed against the locking surface 180 of the casing 120 so as to lock-up the torque-coupling device 100 between the driving shaft and the driven shaft to control sliding movement between the turbine wheel 220 and the impeller wheel 200. Specifically, when an appropriate hydraulic pressure in applied to the locking piston 340, the locking piston 340 moves rightward (as shown in FIG. 15) toward the locking surface 180 of the casing 120 and away from the turbine wheel 220, and clamps the friction liner 350 between itself and the locking surface 180 of the casing 120. As a result, the lock-up clutch 151 in the locked position is mechanically frictionally coupled (or locked) to the casing 120. Thus, the lock-up clutch 151 is provided to bypass the turbine wheel 220 when in the locked position thereof.

During operation, when the lock-up clutch 151 is in the disengaged (open) position, the engine torque is transmitted from the impeller wheel 200 by the turbine wheel 220 of the torque converter 140 to the driven shaft 700 through the turbine hub 800. When the lock-up clutch 151 is in the engaged (locked) position, the engine torque is transmitted by the casing 120 to the driven shaft 700 through the turbine hub 800.

The torsional vibration damper 160 advantageously allows the turbine wheel 220 of the torque converter 140 to be coupled, with torque damping, to the driven shaft, i.e., the input shaft of the automatic transmission. The torsional vibration damper 160 also allows damping of stresses between the driving shaft and the driven shaft that are coaxial with the rotational axis X, with torsion damping.

The torsional vibration damper 160, as best shown in FIG. 15, is disposed axially between the turbine shell 280 of the turbine wheel 220, and the locking piston 340 of the lock-up clutch 151. The locking piston 340 of the lock-up clutch 151 is rotatably and axially slidably mounted to the turbine hub 800. The torsional vibration damper 160 is positioned on the turbine hub 800 in a limited, movable and centered manner. The locking piston 340 forms an input part of the torsional vibration damper 160.

The torsional vibration damper 160 comprises a torque input member 440 rotatable about the rotational axis X, and an integral radially elastic output member 460 elastically coupled to and configured to pivot (i.e., rotate) relative to the torque input member 440 around the rotational axis X. The torque input member 440 includes an annular, radially oriented cover plate 480 adjacent to the turbine shell 280, at least one, preferably two supporting members 600, and a support plate 500 disposed axially opposite the cover plate 480 and adjacent to the piston plate 380, as best shown in FIG. 15. The cover plate 480 is axially spaced from the piston plate 380 and houses the output member 460 axially therebetween. The piston plate 380 is substantially parallel to and axially spaced from the support plate 500. Moreover, the piston plate 380 and the support plate 500 are non-rotatably coupled to one another, such as by the coupling lugs 420 FIG. 16. At the same time, the locking piston 340 (i.e., the piston plate 380 with the integral coupling lugs 420) is axially movable relative to the support plate 500. Thus, the piston plate 380 and the support plate 500 are non-rotatable relative to one another, but rotatable relative to the radially elastic output member 460. Moreover, the locking piston 340 is axially movable relative to the support plate 500. Furthermore, the cover plate 480 is non-movably attached (i.e., fixed) to the turbine shell 280, but placed near the turbine shell 280 so as to be able to rotate with regards to the turbine shell 280. To facilitate the rotation of the cover plate 480 with regard to the turbine hub 800, a turbine washer 810 is non rotatably linked to the turbine hub 800 and present a face which is directly into contact with a face of the cover plate 480.

The support plate 500 is non-rotatably coupled to the cover plate 480. The support plate 500 and the cover plate 480 are non-rotatably coupled together at their upper side. In the exemplary FIG. 16, the support plate 500 and the cover plate 480 are riveted on both sides of the place where is located each of the rolling body 600.

The support plate 500 is in the form of a plate. The support plate 500 is disposed between the piston plate 380 and the cover plate 480.

According to the exemplary embodiment of the present invention, the support plate 500 has a substantially annular radially outer flange 520 FIG. 16. The outer flange 520 of the support plate 500 includes at least one, preferably a plurality, of notches (or recesses) 530n, each complementary to one of the coupling lugs 420. Specifically, the notches 530n are provided in the radially outer flange 520 of the support plate 500. The notches 530n are separated from each other by radially outwardly extending cogs (or teeth) 530t defining the notches 530n therebetween. Each of the coupling lugs 420 positively engages one of the complementary notches 530n so as to non-rotatably couple the locking piston 340 and the support plate 500 while allowing an axial motion of the locking piston 340 with respect to the cover plate 500.

In the exemplary embodiment, the supporting members 600 are in the form of annular rolling bodies, such as cylindrical rollers rotatably mounted to radially external peripheries of the cover plate 480 and the support plates 500, axially between the cover plate 480 and the support plate 500. Each of the rolling bodies 600 is rotatable around a central axis C. The central axis C of each rolling body 600 is substantially parallel to the rotational axis X. The rolling bodies 600 are positioned so as to be diametrically opposite to one another. More specifically, the rolling bodies 600 are rotatably mounted about hollow shafts, which axially extend between the cover plate 480 and the support plate 500. The hollow shafts are mounted on support pins 640 extending axially through the hollow shafts and between the cover plate 480 and the support plate 500. Thus, the support plate 500 provides dimensional stability of the support pins 640. Moreover, the support pins 640 non-rotatably couple the cover plate 48 to the support plate 50 of the torque input member 440. The support plate 500 is non-movably secured to the cover plate 480. The rolling bodies 600 are rotatable around the central axes C, while the support pins 640 are non-movable relative to the cover plate 480 and the support plate 500 of the torque input member 440.

The radially elastic output member 460 includes an annular output hub 540 coaxial with the rotational axis X and rotatable relative the torque input member 440, and at least one and preferably two substantially identical, radially opposite curved elastic blades (or leaves) 560 non-movably connected to (i.e., integral with) the output hub 540. The radially elastic output member 460 is made of steel by fine stamping and heat treatment. According to the exemplary embodiment of the present invention, the radially elastic output member 460, including the output hub 540 and the elastic blades 560, is made as a single-piece part.

The radially elastic output member 460 is configured to elastically and radially engage the rolling bodies 600 and to elastically bend in the radial direction upon rotation of the torque input member 440 with respect to the radially elastic output member 460. A radially inner surface of the output hub 540 includes splines 550 for directly and non-rotatably engaging complementary splines of the turbine hub 800. At the same time, the output hub 540 of the radially elastic output member 460 is axially movable relative to the turbine hub 800 due to a splined connection therebetween. Accordingly, the radially elastic output member 460 is non-rotatably coupled to and axially movable relative to the turbine hub 800.

As best shown in FIG. 16, each of the curved elastic blades 560 is symmetrical with respect to the rotational axis X. Moreover, each of the curved elastic blades 560 has a proximal end 57 non-movably connected (i.e., fixed) to the output hub 540, a free distal end 580, a bent portion 590 adjacent to the proximal end 570, and a curved raceway portion 660 disposed adjacent to free distal end 580 of the elastic blade 560 for bearing one of the rolling bodies 600. Also, the curved raceway portion 660 is connected to the output hub 540 by the bent portion 590. The radially elastic output member 460 with the output hub 540 and the elastic blades 560 is preferably an integral (or unitary) component, e.g., made of a single part, but may be separate components fixedly connected together.

Each of the curved elastic blades 560 and each of the bent portions 590 are elastically deformable. The bent portion 590 subtends an angle of approximately 180°. A radially external surface of the curved raceway portion 660 of each of the curved elastic blades 560 defines a radially outer raceway 680 configured as a surface that is in a rolling contact with one of the rollers 600, so that each of the rolling bodies 600 is positioned radially outside of the elastic blade 560. The raceways 680 of the curved raceway portions 660 of the curved elastic blade 560 extend on a circumference with an angle ranging from about 90° to about 180°. The raceway 680 of each of the curved raceway portions 660 has a generally convex shape. Moreover, as the torque input member 440 is rotatably movable around the rotational axis X relative to the radially elastic output member 460, the rolling bodies 600 are angularly (or circumferentially) displaceable relative to and over the raceways 680 of the curved raceway portions 660 of the curved elastic blades 560.

The curved elastic blades 560 of the radially elastic output member 460 and the rolling bodies 600 are disposed radially within a radially outer edge 510 of the support plate 500 and a radially outer edge 440e of the cover plate 480. In other words, the radially elastic output member 460 and the rolling bodies 600 are entirely or almost entirely covered by the support plate 500 and the cover plate 480 in the axial direction.

At least one, preferably a plurality of therethrough, viewing windows 720 are formed by the cover plate 480 of the torsional vibration damper 160 is formed FIG. 16. In the exemplary embodiment of the present invention, the cover plate 480 of the torsional vibration damper 160 is formed with four (4) viewing windows 720, which are circumferentially spaced from each other around the rotational axis X. The viewing windows 720 are configured to expose a portion of the radially elastic output member 460 of the torsional vibration damper 160, and to allow one determine how the curved elastic blades 560 of the radially elastic output member 460 are angularly oriented, i.e., whether the curved elastic blades 560 extend in the circumferential direction clockwise or counterclockwise around the rotational axis X. In other words, the viewing windows 720 allow an interior space between the support plate 500 and the cover plate 480 of the torsional vibration damper 160 to be observed.

The lock-up clutch 151 is configured to non-rotatably couple the casing 120 and the torque input member 440 in the engaged (locked) position, and configured to drivingly disengage the casing 120 and the torque input member 440 in the disengaged (open) position.

In operation, when each rolling body 600 moves along the raceway 680 of the curved raceway portion 660 of the curved elastic blade 560, the rolling body 600 presses the curved raceway portion 660 of the curved elastic blade 560 radially inwardly, thus maintaining contact of the rolling body 600 with the curved raceway portion 66 of the curved elastic blade 560. Radial forces cause the curved elastic blades 560 to bend, and forces tangential to the raceways 660 of the curved elastic blades 560 allow each rolling body 60 to move (roll) on the raceway 680 of the associated curved elastic blade 560, and to transmit torque from the torque input member 440 to the output hub 540 of the elastic output member 460, and then to the turbine hub 800. Thus, the output hub 540 of the radially elastic output member 460, which is splined directly to the turbine hub 800, forms an output part of the torsional vibration damper 160 and a driven side of the torque-coupling device 100. The locking piston 340, on the other hand, forms an input part of the torsional vibration damper 160. The torque from the driving shaft (or crankshaft) is transmitted to the casing 120 through the studs 130.

In the disengaged position of the lock-up clutch 151, torque flows through the torque converter 140, i.e. the impeller wheel 200 and then the turbine wheel 220 fixed to the turbine hub 800. The torque is then transmitted to the driven shaft (transmission input shaft) splined directly to the turbine hub 800.

In the engaged position of the lock-up clutch 151, torque from the casing 120 is transmitted to the torque input member 440 (i.e., the piston plate 380, the cover plate 480, the support plate 500, and the rolling bodies 600) through the elastic output member 460 formed by the output hub 540 and the elastic blades 560. The torque is then transmitted from the output hub 540 of the radially elastic output member 460 to the driven shaft (transmission input shaft) via the turbine hub 800 splined to the output hub 540. Moreover, when the torque transmitted between the casing 120 and the output hub 540 of the radially elastic output member 460 varies, the radial forces exerted between each of the elastic blades 560 and the corresponding rolling bodies 600 vary and bending of the elastic blades 560 is accordingly modified. The modification in the bending of the elastic blade 560 comes with motion of the rolling body 600 along the corresponding raceway 680 of the curved elastic blade 560.

Each of the raceways 680 has a profile so arranged that, when the transmitted torque increases, the rolling body 600 exerts a bending force on the corresponding curved elastic blade 560, which causes the free distal end 580 of the curved elastic blade 560 to move radially towards the rotational axis X and produces a relative rotation between the casing 120 and the output hub 540 of the radially elastic output member 460. As a result, both the casing 120 and the output hub 540 move away from their relative rest positions. A rest position is that position of the torque input member 440 relative to the radially elastic output member 46, wherein no torque is transmitted between the casing 120 and the output hub 540 of the radially elastic output member 460 through the rolling bodies 600.

The profiles of the raceways 680 are such that the rolling bodies 600 exert bending forces (pressure) having radial and circumferential components onto the curved elastic blades 560. Specifically, the elastic blades 560 are configured so that in a relative angular position between the torque input member 440 and the elastic output member 460 different from the rest position, each of the rolling bodies 600 exerts a bending force on the corresponding elastic blade 560, thus causing a reaction force of the elastic blade 560 acting on the rolling body 600, with the reaction force having a radial component which tends to maintain the elastic blade 560 in contact with the rolling body 600.

In turn, each of the elastic blades 560 exerts on the corresponding rolling body 600 a back-moving force having a circumferential component which tends to rotate the rolling bodies 600 in a reverse direction of rotation, and thus to move the torque input member 440 (thus, the turbine wheel 220) and the output hub 540 of the radially elastic output member 460 back towards their relative rest positions, and a radial component directed radially outwardly, which tends to maintain each of the raceways 680 in direct contact with the corresponding rolling body 600.

When the casing 120 and the radially elastic output member 460 are in the rest position, the elastic blades 560 are preferably radially pre-stressed toward the rotational axis X so as to exert a reaction force directed radially outwards, to thus maintain the curved elastic blades 560 supported by the associated rolling bodies 600. Moreover, the profiles of the raceways 680 are so configured that a characteristic transmission curve of torque according to the angular displacement of the rolling body 600 relative to the raceway 680 is symmetrical or asymmetrical relative to the rest position. According to the exemplary embodiment, the angular displacement of each rolling body 600 relative to the raceway 680 is more important in a direct direction of rotation than in a reverse (i.e., opposite to the direct) direction of rotation.

According to the exemplary embodiment, the angular displacement of the casing 120 relative to the radially elastic output member 460 in the locked position of the lock-up clutch 151 is greater than 20°, preferably greater than 40°. The curved elastic blades 560 are regularly distributed around the rotational axis X and are symmetrical relative to the rotational axis X so as to ensure the balance of the torque converter 140.

A method for assembling the hydrokinetic torque-coupling device 10 is as follows. First, the impeller wheel 200, the turbine wheel 220, the stator 240, and the torsional vibration damper 160 may each be preassembled. The impeller wheel 200 and the turbine wheel 220 are formed by stamping from steel blanks or by injection molding of a polymeric material. The stator 240 is made by casting from aluminum or injection molding of a polymeric material. The impeller wheel 200, the turbine wheel 220, the stator 240 subassemblies and the turbine hub 800 are assembled together so as to form the torque converter 140.

The torsional vibration damper 160 is then added. The cover plate 480 and the support plate 500 are formed by stamping from a steel blank. Before the torque converter 140 and the torsional vibration damper 16 are assembled, the washer 810 is linked to the turbine hub 800.

The locking piston 340 is then added. The piston plate 380 with the connection member 400 is formed by stamping from a steel blank. The locking piston 340 with the connecting member 400 is mounted to the torsional vibration damper 160 so that the locking piston 340 non-rotatably engages the torque input member 440 of the torsional vibration damper 160. Specifically, the coupling lugs 420 of the locking piston 340 non-rotatably engage the complementary notches 530n of the support plate 500 so as to non-rotatably couple the locking piston 340 with the support plate 500 of the torsional vibration damper 160 while allowing an axial motion of the locking piston 340 with respect to the support plate 500.

Then, the cover shell 170₁ is non-movably and sealingly secured, such as by welding at 190, to the impeller shell 170₂, as best shown in FIG. 2. After that, the torque-coupling device 100 is mounted to the driven shaft (i.e., the input shaft of the automatic transmission of the motor vehicle) so that the output hub 540 of the elastic output member 460 of the torsional vibration damper 160 is splined to the transmission input shaft via turbine hub 800 splined connection and the cylindrical flange 390 of the locking piston 340 is slidably mounted over the turbine hub 800.

It should be understood that this exemplary method may be practiced in connection with the other embodiments described herein. This exemplary method is not the exclusive method for assembling the turbine assembly described herein. While the methods for assembling the hydrokinetic torque-coupling device 100 may be practiced by sequentially performing the steps as set forth below, it should be understood that the methods may involve performing the steps in different sequences. The foregoing description of the exemplary embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1-15. (canceled)

16. A hydrokinetic torque-coupling device for coupling a driving shaft and a driven shaft together, comprising:
a casing rotatable about a rotational axis and having a locking surface;
a torque converter including an impeller wheel rotatable about the rotational axis and a turbine wheel disposed in the casing coaxially with the rotational axis, the turbine wheel disposed axially opposite to the impeller wheel and hydro-dynamically rotationally drivable by the impeller wheel;
a lock-up clutch including a locking piston axially movable along
the rotational axis to and from the locking surface of the casing, the locking piston including a substantially radially oriented piston plate; and
a torsional vibration damper comprising
a torque input member including a substantially radially oriented cover plate, a support plate disposed axially opposite the cover plate, and at least one supporting member disposed between the cover plate and the support and mounted to both the cover plate and the support plate; and
a unitary radially elastic output member pivotable relative to and elastically coupled to the torque input member, the radially elastic output member disposed axially between the cover plate and the support plate;
the radially elastic output member including an output hub coaxial with the rotational axis and rotatable relative the torque input member, and at least one curved elastic blade non-movably connected to the output hub and configured to elastically and radially engage the at least one supporting member and to elastically bend in the radial direction upon rotation of the cover plate with respect to the radially elastic output member;
the at least one elastic blade defining a curved raceway configured to bear the at least one supporting member;
the locking piston non-rotatably coupled to the support plate of the torque input member of the torsional vibration damper;
the radially elastic output member being covered from axially opposite sides by the support plate and the cover plate;
the cover plate at least partially covering an axially first outer surface of the radially elastic output member facing the cover plate;
the support plate partially covering an axially second outer surface of the radially elastic output member facing the support plate;
the locking piston having an engagement surface configured to selectively frictionally engage the locking surface of the casing to position the hydrokinetic torque-coupling device into and out of a lockup mode in which the locking piston is mechanically frictionally locked to the casing so as to be non-rotatable relative to the casing.

17. The hydrokinetic torque-coupling device as defined in claim 16, wherein the cover plate covers no less than 70% of an area of the axially first outer surface of the radially elastic output member facing the cover plate, and wherein the support plate covers no more than 90% of an area of the axially second outer surface of the radially elastic output member facing the support plate.

18. The torsional vibration damper as defined in claim 16, wherein the support plate is an annular plate.

19. The hydrokinetic torque-coupling device as defined in claim 16, wherein the impeller wheel includes an impeller shell and the turbine wheel includes a turbine shell disposed axially opposite the impeller shell, and
wherein the casing includes the impeller shell and a cover shell non-movably connected to the impeller shell to establish the casing.

20. The hydrokinetic torque-coupling device as defined in claim 16, wherein the locking piston includes at least one coupling lug axially extending from the locking piston toward the torsional vibration damper,
wherein the support plate includes at least one notch positively engaged by the at least one coupling lug so as to non-rotatably couple the locking piston and the support plate.

21. A hydrokinetic torque-coupling device for coupling a driving shaft and a driven shaft together, comprising:
a casing rotatable about a rotational axis and having a locking surface;
a torque converter including an impeller wheel rotatable about the rotational axis and a turbine wheel disposed in the casing coaxially with the rotational axis, the turbine wheel disposed axially opposite to the impeller wheel and hydro-dynamically rotationally drivable by the impeller wheel;
a lock-up clutch including a locking piston axially movable along the rotational axis to and from the locking surface of the casing, the locking piston including a substantially radially oriented piston plate; and
a torsional vibration damper comprising
a torque input member including a substantially radially oriented cover plate, a support plate disposed axially opposite the cover plate, and at least one supporting member disposed between the cover plate and the support and mounted to both the cover plate and the support plate; and
a unitary radially elastic output member pivotable relative to and elastically coupled to the torque input member, the radially elastic output member disposed axially between the cover plate and the support plate;
the radially elastic output member including an output hub coaxial with the rotational axis and rotatable relative the torque input member, and at least one curved elastic blade non-movably connected to the output hub and configured to elastically and radially engage the at least one supporting member and to elastically bend in the radial direction upon rotation of the cover plate with respect to the radially elastic output member;
the at least one elastic blade defining a curved raceway configured to bear the at least one supporting member;
the locking piston non-rotatably coupled to the cover plate of the torque input member of the torsional vibration damper;
the radially elastic output member being covered from axially opposite sides by the piston plate and the cover plate;
the cover plate at least partially covering an axially first outer surface of the radially elastic output member facing the cover plate;
the support plate partially covering an axially second outer surface of the radially elastic output member facing the support plate;
the locking piston having an engagement surface configured to selectively frictionally engage the locking surface of the casing to position the hydrokinetic torque-coupling device into and out of a lockup mode in which the locking piston is mechanically frictionally locked to the casing so as to be non-rotatable relative to the casing.

22. The hydrokinetic torque-coupling device as defined in claim 21, wherein the cover plate covers no less than 70% of an area of the axially first outer surface of the radially elastic output member facing the cover plate, and wherein the support plate covers no more than 30% of an area of the axially second outer surface of the radially elastic output member facing the support plate.

23. The hydrokinetic torque-coupling device as defined in claim 21, wherein the support plate is a rectangular plate or annular plate.

24. The hydrokinetic torque-coupling device as defined in claim 16, wherein the output hub of the radially elastic output member is rotatable relative to the turbine wheel.

25. The hydrokinetic torque-coupling device as defined in claim 16, wherein the at least one supporting member is covered in the axial direction by the piston plate and the cover plate.

26. The hydrokinetic torque-coupling device as defined in claim 16, wherein the cover plate is non-rotatably coupled to the turbine wheel.

27. The hydrokinetic torque-coupling device as defined in claim 16, wherein the locking piston further includes a connection member non-movable relative to the piston plate, and wherein the connection member includes at least one coupling lug non-rotatably coupling the piston plate to the cover plate of the torque input member of the torsional vibration damper.

28. The hydrokinetic torque-coupling device as defined in claim 16, wherein the locking piston is non-rotatably coupled to and axially movable relative to the torque input member of the torsional vibration damper.

29. The hydrokinetic torque-coupling device as defined in claim 17, wherein the locking piston includes at least one coupling lug axially extending from the locking piston toward the torsional vibration damper, wherein the cover plate includes at least one notch positively engaged by the at least one coupling lug so as to non-rotatably couple the locking piston and the cover plate.

30. A method for assembling a torsional vibration damper of a hydrokinetic torque-coupling device for coupling a driving shaft and a driven shaft together, the method comprising the steps of:
providing a piston plate, a cover plate, a support plate and at least one supporting member;
providing a unitary radially elastic output member including an output hub and at least one curved elastic blade non-movably connected to the output hub and
configured to elastically and radially engage the at least one supporting member and to elastically bend in the radial direction;
mounting the at least one supporting member to the cover plate;
placing the unitary radially elastic member axially between the cover plate and the piston plate so that the at least one elastic blade elastically and radially engages the at least one supporting member;
mounting the support plate to the cover plate so that the at least one supporting member is disposed between the cover plate and the support plate; and
non-rotatably mounting the piston plate to the cover plate so that the radially elastic output member being covered from axially opposite sides only by the piston plate and the cover plate;
the cover plate at least partially covering an axially first outer surface of the radially elastic output member facing the cover plate;
the support plate partially covering an axially second outer surface of the radially elastic output member facing the support plate.
